(19) United States
(12) Patent Application Publication
(10) Pub. No.: US 2018/0162746 A1
(43) Pub. Date: Jun. 14, 2018

(54) Method of removing dissolved silica from waste water

(71) Applicants: James L. Krumhansl, (US); Sandia Corporation, Albuquerque, NM (US)

(72) Inventors: Tina N. Nenoff, Albuquerque, NM (US); Koroush Sasan, Albuquerque, NM (US); Patrick V. Brady, Albuquerque, NM (US); James L. Krumhansl, Albuquerque, NM (US)

(21) Appl. No.: 15/374,835

(22) Filed: Dec. 9, 2016

(51) Int. Cl. C02F 1/28; B01J 41/02; B01J 41/10

(52) U.S. Cl. CPC C02F 1/281; C02F 2001/422; B01J 41/10; B01J 41/02

(57) ABSTRACT

Dissolved silica is ubiquitous in impaired waters, a fouling agent in desalination membranes, resistant to existing antiscalants, and difficult to remove from power plant feed waters, thereby inhibiting long term reuse of industrial water. According to the present invention, an inorganic anion exchanger, hydrotalcite (HTC), can provide highly selective removal of silica from aqueous solutions. Calcined HTC effectively removes silicate anion from different waste waters and waters with high concentration of competing ions, such as SO₄²⁻ and Cl⁻. For example, calcined Mg₆Al₂(OH)₁₆(CO₃).4H₂O has a silica adsorption capacity of 45 mg SiO₂/g HTC. Further, HTC can be easily regenerated and recycled.

### STATEMENT OF GOVERNMENT INTEREST

This invention was made with Government support under contract no. DE-AC04-94AL85000 awarded by the U. S. Department of Energy to Sandia Corporation. The Government has certain rights in the invention.

### FIELD OF THE INVENTION

The present invention relates to water treatment and reuse, in particular, to a method of removing dissolved silica from waste water.

### BACKGROUND OF THE INVENTION

Fresh water scarcity is becoming a great global challenge. Water resources are limited and, hence, water treatment and recycling methods are vital alternatives for fresh water procurement in the upcoming decades. See V. K. Gupta et al., RSC Advances 2, 6380 (2012). These methods serve to remove harmful or problematic constituents from ground, surface and waste waters prior to their consumption, industrial utilization/reuse, or other uses. See N. Abdel-Raouf et al., Saudi Journal of Biological Sciences 19, 257 (2012).

Dissolved silica is ubiquitous in impaired waters, a fouling agent in desalination membranes, resistant to existing antiscalants, and difficult to remove from power plant feed waters, thereby inhibiting long term reuse of industrial water. About half of all fresh water withdrawn daily in the US, ˜500 billion gal/day, is used by thermoelectric power generation plants. See K. Averyt et al., The Union of Concerned Scientists' Energy and Water in a Warming World Initiative 2011. The recovery cost for the impaired waters produced by inland power generation sites is estimated to be 1.5-2 times the cost of freshwater, often because of the high cost of removing silica. A key solution to limited availability and high cost is reducing freshwater use and replacement of it with reclaimed waters, such as those from purified oilfield generated waters, municipal or agricultural waste waters, and subsurface brines. See Use of Degraded Water Sources as Cooling Water in Power Plants, Electric Power Research Institute (EPRI) 2003, Report 1005359.

However, to be successful, dissolved silica and calcite forming mineral scale need to be removed. Antiscalant technology is well developed for calcite removal. However, a low energy technology is needed for silica removal. The quality of the process affects the reuse and recycle of the reclaimed waters in individual operation. Currently, antiscaling technology enables ˜10 recycles with calcite removal, however it is reduced down to 1-2 cycles due to silica buildup. See Use of Degraded Water Sources as Cooling Water in Power Plants, Electric Power Research Institute (EPRI) 2003, Report 1005359.

Therefore, a need remains for a robust, energy efficient, and low cost method of removing dissolved silica from waste water.

### SUMMARY OF THE INVENTION

The present invention is directed to a fast, energy efficient and low cost material for the removal of silica ions from industrial waters: the high selectivity anion-exchanger hydrotalcite (HTC). HTCs have a variety of compositions which have unique silica uptake abilities. Examples of HTCs include (but are not limited to) Mg₆Al₂(OH)₁₆(CO₃).4H₂O (Mg-Al—HTC) and Zn₆Al₂(OH)₁₆.4H₂O (Zn—Al-HTC). By utilizing the solubility of silica in water at varying pHs, and the selectivity of the HTC ion-exchange material, >90% silicate anion removal can be obtained from waste waters and waters with competing ions such as S0₄²⁻ and Cl⁻. Further, the spent HTC can be regenerated and reused multiple times.

### BRIEF DESCRIPTION OF THE DRAWINGS

The detailed description will refer to the following drawings, wherein like elements are referred to by like numbers.

FIG. 1 is a schematic illustration of a method for removing dissolved silica from waste water, using hydrotalcite (HTC) as an ion exchange material.

FIG. 2 is a plot of powder X-ray diffraction (XRD) patterns of uncalcined HTC, calcined HTC after heating in air at 550° C., and regenerated HTC after mixing with concentrated cooling tower water (CCTW).

FIG. 3 is a graph of Fourier transform infrared (FTIR) spectra of uncalcined HTC, calcined HTC and HTC after ion-exchanged. The peak at 3400 cm⁻¹ is the absorption spectra of —OH, and the peak at 1634 cm⁻¹ corresponds to CO₃²⁻.

FIG. 4 is a graph of silica removal from CCTW by uncalcined HTC and calcined HTC (pH=7.0, 25° C., 50 mg/L SiO₂).

FIG. 5 is a graph of time-dependent silica removal during ion-exchange by calcined HTC (75 mg HTC, pH=7.5, 50 mg/L SiO₂).

FIG. 6 is a graph of a Single Path Flow Through (SPFT) test showing silica removal from CCTW (pH=7.0, 25° C., 50 mg/L SiO₂) using 200 mg calcined HTC with a flow rate of 0.15 ml min⁻¹. Arrows are included to clarify axes.

FIG. 7 is a graph of the pH of CCTW solutions after treatment with calcined HTC. At pH>9.5 the silica exists as a H₃SiO₄⁻ anion.

FIG. 8 is a graph of the SEM-EDS pattern of calcined HTC after silica adsorption from CCTW. It confirms the presence of silica and chlorine.

FIG. 9 is a graph of XRD patterns of HTC after regeneration cycles with CCTW. A1 is the original HTC sample. Cycle 1 (A2/A3) is regeneration calcination and recrystallization of the HTC. Cycles 2 (A4/A5), 3 (A6/A7), and 4 (A8) are subsequent regeneration cycles.

FIG. 10 is a graph of silica removal by calcined HTC; pseudo-second order equation plot, R² value=0.99.

### DETAILED DESCRIPTION OF THE INVENTION

Silica solubility depends on many factors, such as pH, temperature, pressure, and ionic strength. The silica solubility is constant between pH 2 and 8.5, but increases rapidly above pH 9. In the acidic-to-neutral pH range, silica exists as H₄SiO₄, whereas in basic solutions, it exists as H₃SiO₄⁻ and H₂SiO₄²⁻ anionic species. See H.-H. Cheng et al., Separation and Purification Technology 70, 112 (2009); and I. Latour et al., Environmental Science and Pollution Research 23, 3707 (2015). Silica solubility is also highly sensitive to temperature, increasing from 100-140 mg/L at ambient temperature, and then up to 300 mg/L at 70° C. See I. Latour et al., Chemical Engineering Journal 230, 522 (2013).

Dissolved silica can be removed by a number of different methods including coagulation, nano-filtration (NF), reverse osmosis (RO), or precipitation. See I. Latour et al., Environmental Science and Pollution Research 23, 3707 (2015); I. Latour et al., Chemical Engineering Journal 230, 522 (2013); D. Hermosilla et al., Chemical Engineering & Technology 35, 1632 (2012); Y. Liu et al., Ind. Eng. Chem. Res. 51, 1853 (2012); and D. L. Gallup et al., Applied Geochemistry 18, 1597 (2003). Major limitations of NF and RO are fouling and high energy consumption. See S. Salvador Cob et al., Separation and Purification Technology 140, 23 (2015). The drawback of coagulation is that the process occurs at high pH, resulting in increased costs due to pH adjustment. See D. Hermosilla et al., Chemical Engineering & Technology 35, 1632 (2012). The current technology of alumina precipitation may cause aluminosilicate scaling. See S. Salvador Cob et al., Separation and Purification Technology 140, 23 (2015).

In an effort to develop highly selective silica ion-exchange materials that are robust, low cost and energy efficient, inorganic anion exchangers such as hydrotalcites (HTC) have been explored as silica adsorbents. HTCs are layered double-hydroxides with the general formula [M^{(II)}₁₋ₓM(III)ₓ(OH)₂]^{x+}[A].mH₂O where M^{(II)}=Mg²⁺, Mn²⁺, Fe²⁺, Co²⁺, Ni²⁺, and Zn²⁺; M^{(III)}=Al³⁺, Cr³⁺, Mn³⁺, Fe³⁺, Co³⁺, and Ga³⁺; and A=Cl⁻, Br⁻, I⁻, NO₃⁻, CO₃²⁻, SO₄²⁻, silicate-, polyoxometalate-, and/or organic anions. See A. Fahami and G. W. Beall, Journal of Solid State Chemistry 233, 422 (2016); and R. P. Bontchev et al., Chem. Mater 15, 3669 (2003). HTC is made up of positively charged [M^{(II)}/M^{(III)}/OH] layers, which have a substantial anion exchange capacity of ˜3 meq/g. See J. D. Pless et al., Ind. Eng. Chem. Res. 45, 4752 (2006); and D. Wan et al., Chemical Engineering Journal 195-196, 241 (2012). HTC has been shown to be a highly selective anion exchange material in a low energy, brackish water, desalination process. See J. D. Pless et al., Ind. Eng. Chem. Res. 45, 4752 (2006).

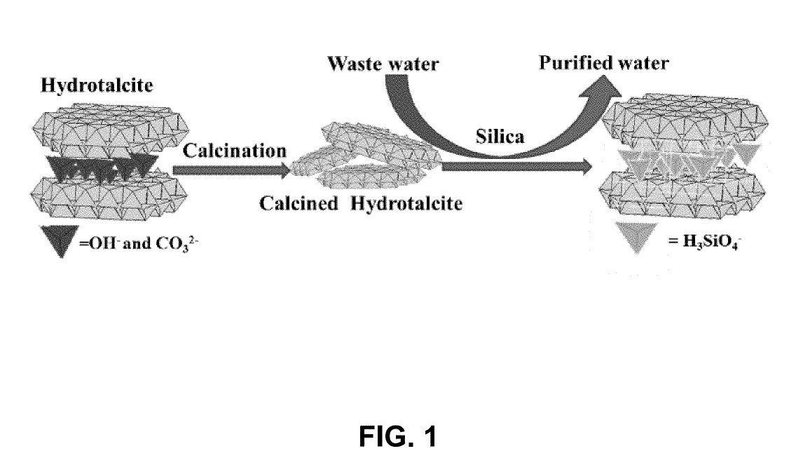

As shown in FIG. 1., the present invention uses HTC as an ion-exchange material for the selective ion-exchange and capture of silica ions from waste water. Typically, the removal of silica ions is improved by calcining the HTC at 500 to 600° C. for 0.5 to 4 hours. Likewise, the spent HTC can be regenerated under similar conditions. Material studies of the HTC, the mechanism of silica ion capture, and the efficiency of HTCs for silica removal from simulated industrial waters are described below. Detailed HTC synthesis, structural characterization and silica removal measurements are described at various pH readings and concentrations levels. Furthermore, the adsorption kinetics of the silica removal is described.

### HTC Characterization

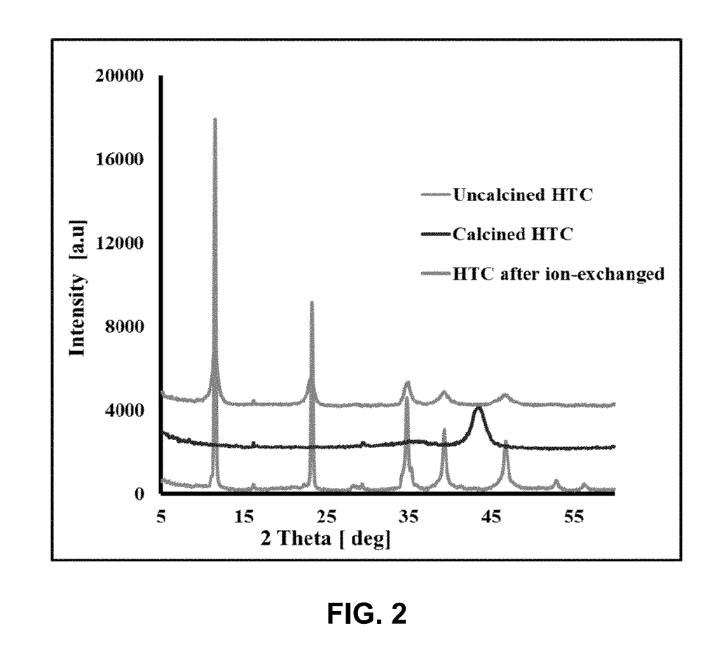

As an example of the invention, 15 g batches of a commercially available HTC (Sigma-Aldrich), (Mg₆Al₂(OH)₁₆(CO₃).4H₂O), were calcined in air at 550° C. for 3 h. See D. G. Cantrell et al., Applied Catalysis A: General 287, 183 (2005). The surface area of the calcined HTC was ˜138 m²/g, whereas the surface area of the uncalcined HTC was ˜12 m²/g, as determined by the Brunauer-Emmet-Teller (BET) method. The higher surface area for calcined HTC can be a result of the decrease in HTC crystal size caused by thermal treatment, as shown in related studies. See K.-H. Goh et al., Water Research 42, 1343 (2008); and G. Fetter et al., Journal of Porous Materials 8, 227 (2001). This decrease in crystal size is supported by the broadening of powder X-ray diffraction (XRD) peaks for calcined HTC, as shown in FIG. 2. The XRD pattern indicates that the HTC structure collapsed and formed mixed oxide during heat treatment, according to the reaction:

Mg₆Al₂(OH)₁₆(CO₃).4H₂O [symbol] 5MgO.MgAl₂O₄+CO₂+H₂O (1)

See J. C. Roelofs et al., Chemistry—A European Journal 8, 5571 (2002). The calcined HTC can be reconstructed to its original structure when mixed in water containing anions of the correct size, charge and/or size in the interlayer of the recrystallized HTC. See H. Wang et al., Applied Clay Science 35, 59 (2007); and K. L. Erickson et al., Materials Letters 59, 226 (2005).

Thermogravimetric analysis (TGA) of uncalcined HTC shows that thermal decomposition of HTC takes place at two distinct steps. In Step I, the initial mass loss begins at room temperature and ends at ˜250° C., with ˜14% mass lost. This corresponds to the loss of water molecules located between the Mg/Al/OH layers. See L. Lv et al., Journal of Hazardous Materials 152, 1130 (2008). In Step II, the additional mass loss of ˜31% occurs between ˜250° C. and 510° C. Concurrent thermogravimetric-mass analysis (TGA-MS) indicates a mass loss of ˜7% is associated with carbonate anions, followed by gradual mass loss of ˜24% corresponding to loss of interlayer water molecules (condensation of OH groups from the Mg/Al/OH layers). See L. Lv et al., Journal of Hazardous Materials 152, 1130 (2008). The corresponding XRD shows the HTC becomes an amorphous phase upon calcination. The transition in the structural formulas during the two steps are:
Step I: (Mg₆Al₂(OH)₁₆(CO₃).4H₂O)-4H₂O [symbol] (Mg₆Al₂(OH)₁₆(CO₃)) (Calc. Wt. Loss=11.9%)
Step II: (Mg₆Al₂(OH)₁₆(CO₃))—CO₂-8H₂O [symbol] 5MgO.MgAl₂O₄ (Calc. Wt. Loss=31.2%)

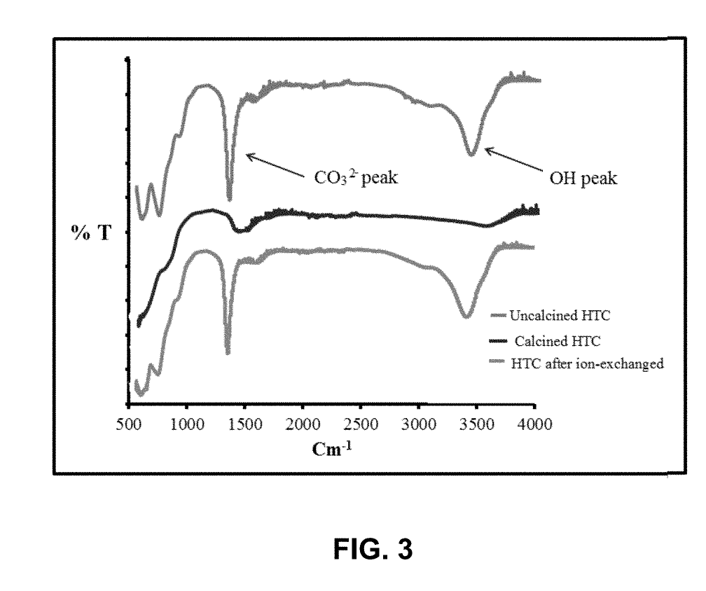

As shown in FIG. 3, direct comparison of Fourier transform infrared (FTIR) data for uncalcined and calcined HTC clearly shows the decrease in intensity of calcined infrared peaks, which confirms the decarbonisation and dihydroxylation of the HTC during the calcination process. In the uncalcined HTC data, a peak at 3400 cm⁻¹ is attributed to the metal hydroxide and water adsorbed into the Mg/Al/OH layers. See Q. Tao et al., Journal of Solid State Chemistry 179, 708 (2006); V. Rives, Materials Chemistry and Physics 75, 19 (2002); and J. T. Kloprogge et al., Journal of Materials Science Letters 21, 603 (2002). The peak at 1434 cm⁻¹ is attributed to a carbonate of uncalcined HTC. See T. Stanimirova et al., Journal of Materials Science 34, 4153 (1999). After calcination, the peak at 3400 cm⁻¹ has almost disappeared, which is the indicative of dehydration during thermal treatment. Also, the peak at 1434 cm⁻¹ has shifted to 1537 cm⁻¹ indicating the carbonate in the uncalcined HTC sample has undergone a symmetric change during the calcination process due to the eliminated water from the HTC structure.

### Mechanism of Silica Removal

Two different adsorption mechanisms have been used to describe the silica removal by HTC. The first process is direct ion-exchange with the interlayer anions of uncalcined HTC. See K.-H. Goh et al., Water Research 42, 1343 (2008). The second process, shown in FIG. 1, involves the silica removal by calcined HTC, in which the amorphous (collapsed) calcined HTC material is dispersed into an aqueous solution containing dissolved silica, and the HTC structure recrystallizes around silicate anions (H₃SiO₄⁻). See K.-H. Goh et al., Water Research 42, 1343 (2008); Q. Wang and D. O'Hare, Chem. Rev 112, 4124 (2012); and J. He et al., “Preparation of Layered Double Hydroxides,” in Layered Double Hydroxides, Springer Berlin Heidelberg: Berlin, Heidelberg, 2006; pp 89-119.

To understand which ion-exchange mechanism favors silica removal, both uncalcined HTC and calcined HTC were individually treated with synthetic industrial water (Concentrated Cooling Tower Water, CCTW). The CCTW was made by salt addition to DI water with the following concentrations (mmol/L): 0.41 MgCl₂+0.05 Na₂SO₄+0.62 NaHCO₃+1.0 CaCl₂+41.0 NaCl+0.833 SiO₂. For the batch silica removal reactions, typically 25-125 mg of HTC was added to 50 ml of the synthetic CCTW in 50 ml tubes, and the tube placed on a shaker table for 12 hours at room temperature. After shaking, the slurry was centrifuged, and the pH and silica concentration of the supernatant were determined. The percentage of silica removal was calculated based on the mass of silica removed by HTC to the initial mass of silica in water. The silica adsorption capacity is defined as the mass of silica removed from solution to the mass of calcined HTC used for silica removal.

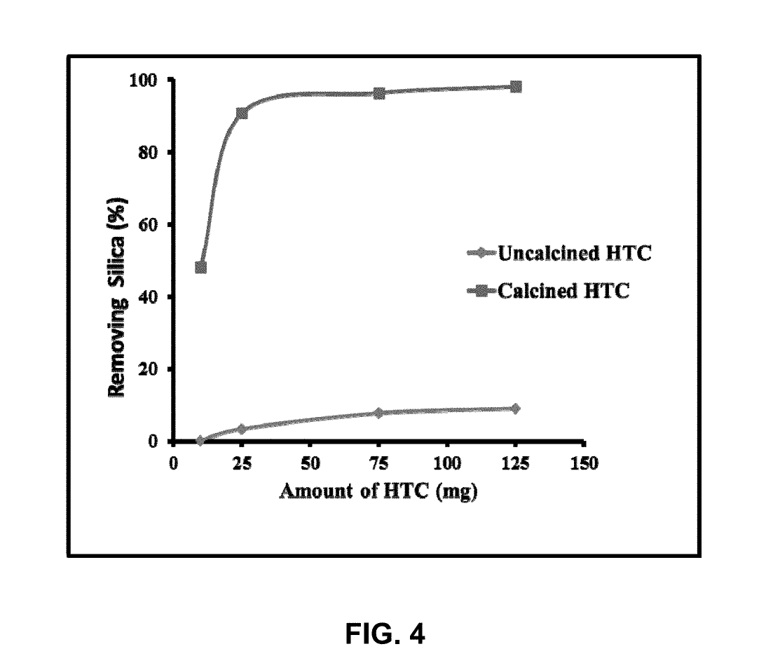

As shown in FIG. 4, using either 75 or 125 mg of calcined amorphous HTC resulted in more than 90% silica removal. By contrast, using 125 mg of crystalline (uncalcined) HTC resulted in only 10% silica removal. This demonstrates that the calcined HTC is a more effective silica removal material than uncalcined HTC. The silica adsorption capacity of calcined HTC is approximated to be 45 mg SiO₂/g HTC. In the process of HTC calcination, higher surface area is generated that is available for ion-exchange which results in higher silica removal on calcined HTC (˜138 m²/g) compared to uncalcined (˜12 m²/g).

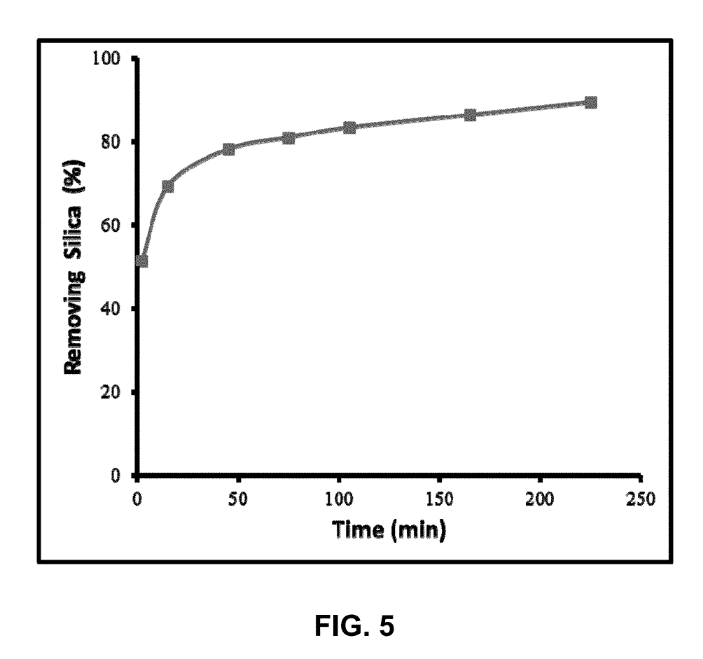

Silica adsorption by HTC as a function of time was also determined. In these experiments, 75 mg of calcined HTC was added to 50 ml of synthetic CCTW in a 50 ml tube; the tube was placed on shaker for a given time, up to 250 min. The resultant slurry was centrifuged, and silica concentration of the supernatant was determined by optical spectrophotometry. FIG. 5 shows data from time-dependent silica removal studies. Silica removal starts at a rapid rate in the first 25 minutes. However, the adsorption rate slows and reaches equilibrium early (˜50 mins) and is completed by ˜200 minutes.

### Single Path Flow Through (SPFT) Measurement

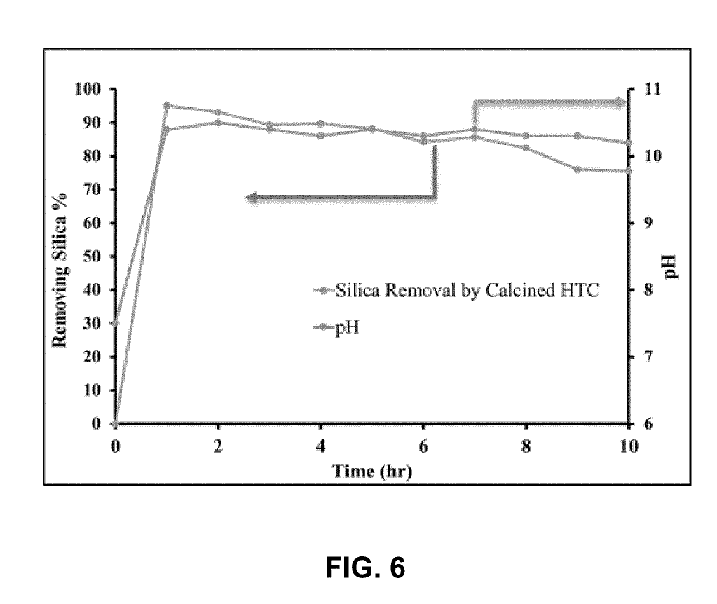

A SPFT test was used to measure HTC uptake of silica under more rapid flow-through conditions and to provide a measure of uptake capacity. The SPFT measurement was done using synthetic CCTW and calcined HTC. See J. D. Pless et al., Ind. Eng. Chem. Res. 45, 4752 (2006). CCTW was pumped through columns containing 100-200 mg of calcined HTC at a flow rate of 0.15 ml min⁻¹. Treated CCTW effluent was periodically collected and the silica concentration and pH determined. The steady state volume of fluid in the reactor was ˜1 ml, which indicates an average fluid residence time of ˜7 minutes. As shown in FIG. 6, greater than >90% silica removal occurs rapidly and persists until ˜4 hours, at which point the rate of silica removal declines. The SPFT results indicates a silica adsorption capacity for calcined HTC of ˜45 mg SiO₂/g HTC which agrees well with adsorption capacity measurement from the batch testing.

### Effect of pH on Silica Removal by Calcined HTC

To measure the effect of pH, 25-125 mg of calcined HTC was added to 50 ml of the synthetic CCTW at pH 4-9 (the initial pH was adjusted by addition of 0.1 mol/L HCl or NaOH). The solution was placed on a shaker table for 12 hours at room temperature, then the slurry was centrifuged and the pH of solution was measured.

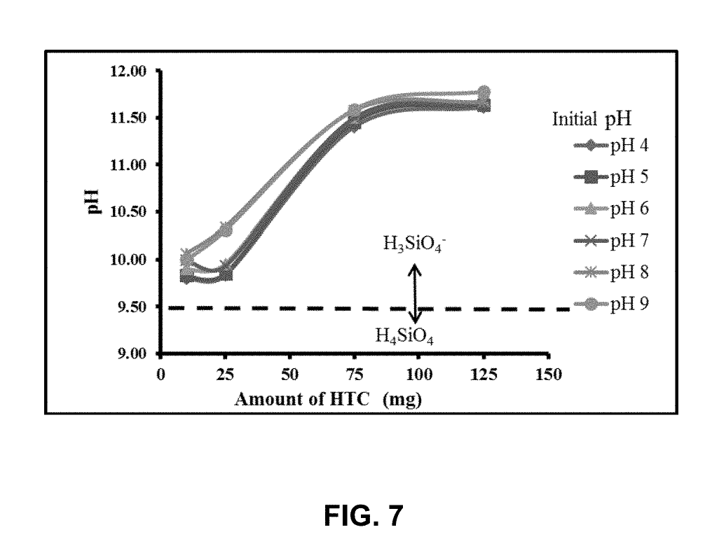

Changing the initial pH from 4 to 9 results in no significant effect on the silica removal performance by calcined HTC. Silica exists in the neutral form (H₄SiO₄) in the initial pH range (4-9), and is not available for ion-exchange. See N. A. Milne et al., Water Research 65, 107 (2014). As shown in FIG. 7, the pH of the solution rapidly increased to ≥9.8 after the addition of calcined HTC to the CCTW solution; this is concurrent with the formation of H₃SiO₄⁻ silica ions in solution.

Changing the solution pH and the adsorption of silica ions by calcined HTC occurs as follows:

(1) OH ions are generated during reconstruction of HTC from magnesium and aluminum mixed oxides to the original crystalline structure. Concurrently, all available ions (Cl⁻, HCO₃⁻, etc.) are adsorbed into the HTC interlayer, according to Eq. (2):

5MgO.MgAl₂O₄+13H₂O+2Cl⁻ [symbol] Mg₆Al₂(OH)₁₆Cl₂.4H₂O+2OH⁻ (2)

(2) As the pH rises to greater than 9.5, most of the silica is in the form of H₃SiO₄⁻ ions, as shown in FIG. 7, and thus is available for ion-exchange by the HTC according to the method shown in FIG. 1. See I. Latour et al., Environmental Science and Pollution Research 23, 3707 (2015); and N. A. Milne et al., Water Research 65, 107 (2014). Remaining oxides crystallize to HTC with the adsorbed silicate anions in the interlayers, according to Eq. (3):

5MgO.MgAl₂O₄+13H₂O+H₃SiO₄⁻ [symbol] Mg₆Al₂(OH)₁₆(H₃SiO₄)ₓ.4HO₂+2OH⁻ (3)

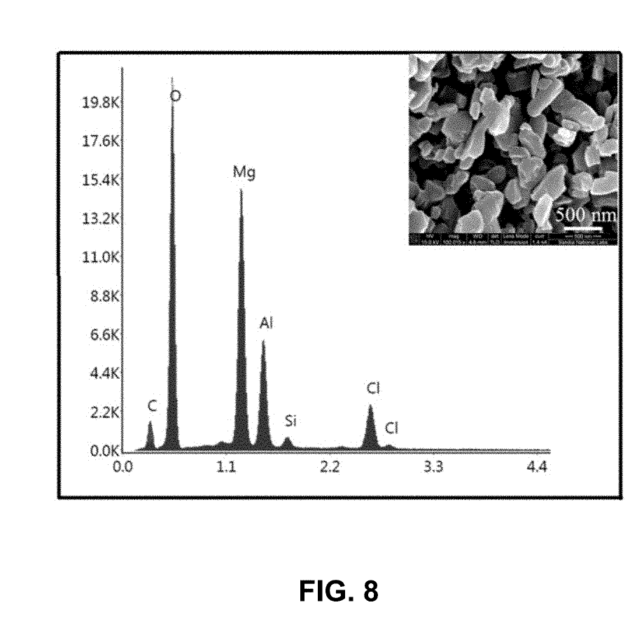

As shown in FIGS. 2 and 3, XRD and FTIR analyses confirm the recrystallization of HTC after exposure to CCTW. Scanning electron microscopy—energy dispersive spectroscopy (SEM-EDS) confirmed the presence of both silica and chlorine in the regenerated HTC phase, as shown in FIG. 8.

### Effect of Competing Ions on Silica Removal by Calcined HTC

Cooling tower water contains ions such as sulfate and chloride which might compete with silica for HTC adsorption sites. See W. Ma et al., Desalination 268, 20 (2011). Therefore, the ability of HTC to adsorb silica in the presence of competing anions was examined. To determine the effect of competing anions, binary solute systems of SiO₂/SO₄²⁻ and SiO₂/Cl⁻ (NaCl and Na₂SO₄ as sulfate and chloride sources), respectively, were measured with calcined HTC. Specifically, the binary-solute systems were mixed with the initial SiO₂ concentration (50 mg/L) and the calcined HTC (125 mg). Table 1 shows that at silicate/chloride=1/20, ˜98% of dissolved silica was removed suggesting a strong preference of HTC for silicate over chloride. Similarly, at silicate/sulfate=1/20, ˜95% of the silicate was removed. The slightly lower silica removal in the presence of sulfate may be a due to the higher charge of SO₄²⁻ over Cl⁻. See J. D. Pless et al., Ind. Eng. Chem. Res. 45, 4752 (2006). Overall, these results indicate that silica adsorption by calcined HTC is selective in the presence of competing ions, such as Cl⁻ and SO₄²⁻.

TABLE 1
Percent silica removal by HTC in presence of varying
concentration of chloride and sulfate ions (initial silica concentration
50 mg/L, 50 ml, 125 mg HTC).

| Sample ratio | | Sample ratio | Removed |
|---|---|---|---|
| Silica:Chloride | Removed silica (%) | Silica:Sulfate | Silica (%) |
| 1:1 | 99.0% | 1:1 | 99.0% |
| 1:5 | 98.8% | 1:5 | 97.0% |
| 1:10 | 98.5% | 1:10 | 95.8% |
| 1:15 | 97.9% | 1:15 | 95.2% |
| 1:20 | 97.6% | 1:20 | 94.8% |

### Regeneration of HTC

To determine the effect of HTC regeneration, the spent HTC was dried overnight in air at 60° C., and heated at 550° C. for 2 h. This process allowed for the regeneration of the crystalline HTC after each subsequent calcination for the silica removal process. The HTC after each subsequent calcination was used again for the removal of silicate anion from CCTW.

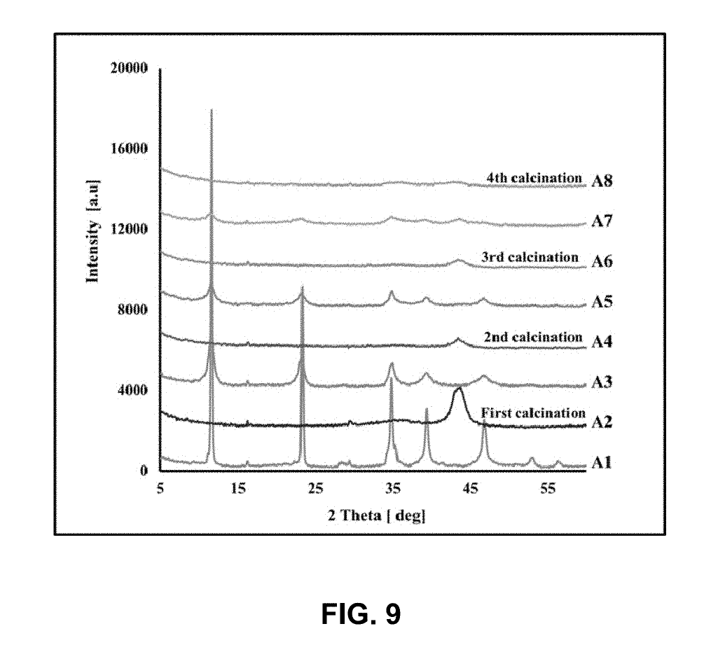

Regeneration cycling of the HTC involves cycles of calcination and reconstruction. Utilizing a non-optimized stoichiometry of the Mg—Al-HTC, no appreciable decrease in silica ion adsorption capacity was seen in the material after three recycles; a slight decrease was seen after the fourth cycle. Additional recycles allow for continued silica ion removal from the aqueous solution. The change in the sorption capacity was influenced by the ability of calcined HTC to regenerate the layered crystal structure during the ion-exchange process. As shown in FIG. 9, XRD of HTC after each regeneration shows a decreased in HTC crystallinity (peak intensities). See F. Teodorescu et al., Materials Research Bulletin 48, 2055 (2013). The decreased ability of calcined HTC to recrystallize to the original HTC structure after each regeneration cycle was commensurate with the decrease in silica adsorption capacity.

### Kinetics of Silica Removal by Calcined HTC

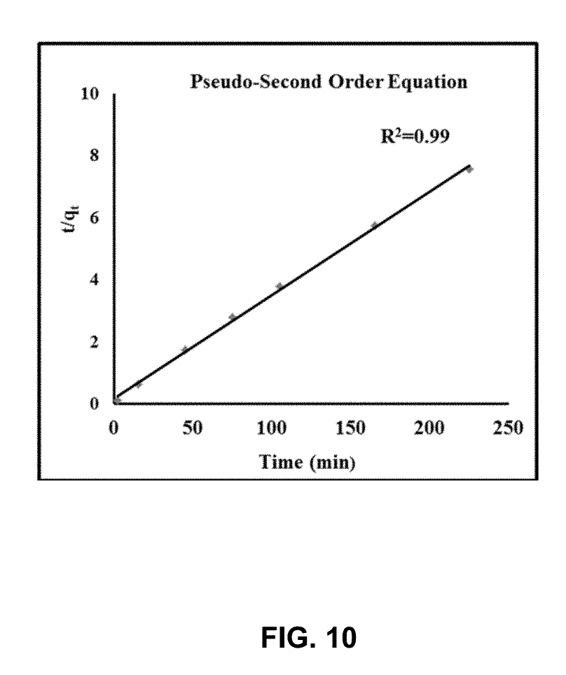

The silica adsorption kinetics were best represented by a pseudo-second order equation, [t/qₜ=1/k₂¹qe²+t/qₑ], where k₂¹ (g/mg/min) is the pseudo-second order rate constant. See D. Folasegun Anthony et al., International journal of multidisciplinary sciences and engineering 3, 21 (2012); A. El Nemr et al., Arabian Journal of Chemistry 8, 105 (2015); and S. Nethaji et al., Bioresource Technology 134, 94 (2013). The values of t/qₜ plotted against given time (t) are shown in FIG. 10. The regression coefficient value (R²) of 0.99 indicated that this model provides an excellent fit to the experimental data for removing silica.

Fitting this model implies that the rate of silica adsorption on the calcined HTC ion-exchanged sites is proportional to the square of the number of unoccupied active sites. See D. Folasegun Anthony et al., International journal of multidisciplinary sciences and engineering 3, 21 (2012). Since the ion-exchange kinetics is largely controlled by the active sites of calcined HTC available for sorption, the initial fast rate of ion-exchange, shown in FIG. 5, is attribute to the availability of adsorption free sites especially on the surface of the calcined HTC.

The present invention has been described as a method of removing dissolved silica from waste water. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method for removing dissolved silica from waste water, comprising dispersing calcined hydrotalcite in an aqueous solution containing dissolved silica, whereby the hydrotalcite captures silicate ions from the aqueous solution.

2. The method of claim 1, wherein the hydrotalcite comprises [M^{(II)}₁₋ₓM^{(III)}ₓ(OH)₂]^{x+}[A].mH₂O where M^{(II)}=Mg²⁺, Mn²⁺, Fe²⁺, Co²⁺, Ni²⁺, and Zn²⁺; M^{(III)}=Al³⁺, Cr³⁺, Mn³⁺, Fe³⁺, Co³⁺, and Ga³⁺; and A=Cl⁻, Br⁻, I⁻, NO₃⁻, CO₃²⁻, SO₄²⁻, silicate-, polyoxometalate-, and/or organic anions.

3. The method of claim 2, wherein the hydrotalcite comprises Mg₆Al₂(OH)₁₆(CO₃).4H₂O.

4. The method of claim 2, wherein the hydrotalcite comprises Zn₆Al₂(OH)₁₆.4H₂O.

5. The method of claim 1, wherein the hydrotalcite is calcined at a temperature greater than 500° C.

6. The method of claim 1, wherein in the pH of the aqueous solution is greater than 9.5.

7. The method of claim 1, wherein the aqueous solution further comprises sulfate or chloride.

8. The method of claim 1, further comprising regenerating the hydrotalcite that is spent after capturing of the silicate ions from the aqueous solution.

9. The method of claim 8, wherein the regenerating comprising heating the spent hydrotalcite to a temperature greater than 500° C.
